(19) United States
(12) Patent Application Publication
(10) Pub. No.: US 2024/0149537 A1
(43) Pub. Date: May 9, 2024

(54) METHOD FOR PRODUCING A SHAPED BODY FROM PLASTIC WASTE AND NATURAL FIBRES

(71) Applicants: Reimund DANN, Warendorf (DE); Alexander HUWE, Bad Vilbel (DE)

(72) Inventors: Reimund DANN, Warendorf (DE); Alexander HUWE, Bad Vilbel (DE)

(21) Appl. No.: 18/281,370

(22) PCT Filed: Mar. 15, 2022
(86) PCT No.: PCT/EP2022/056748

§ 371 Date: Sep. 11, 2023

(30) Foreign Application Priority Data
Mar. 15, 2021 (DE) 10 2021 106 195.4

(51) Int. Cl. B29C 70/06; B29B 17/00; B29B 17/02; B29B 17/04; B29C 70/42; B29K 105/12

(52) U.S. Cl. CPC B29C 70/06; B29B 17/0042; B29B 17/02; B29B 17/0412; B29C 70/42; B29B 2017/0268; B29K 2105/12

(57) ABSTRACT

A method produces a shaped body from plastic waste and thermoplastic material including natural fiber components or thermoplastic material and natural fibers. Plastic waste and thermoplastic plastic including natural fiber components or thermoplastic plastic and natural fibers are introduced into a mixing device. The introduced materials are subsequently mixed in such a way that the materials are comminuted and at least partially melted, so that a substantially moldable base material is available after mixing. This at least partially melted base material is transferred into a mold for shaping the shaped body.

The invention relates to a method in which a shaped body is produced from plastic waste and natural fibers. Furthermore, the invention relates to a railroad tie as a shaped body produced by the method.

A corresponding shaped body in the form of a railroad tie can be found in DE 699 29 819 T2. The railroad tie has a hard inner core as a reinforcement in the form of an elongated reinforcing element, which in turn is surrounded by an outer housing made of a deformable composite material. The outer housing is of double-shell design and consists of polyethylene and ground rubber particles.

Structural and production-related disadvantages arise from double-shell design, wherein in particular a geometric adaptation of reinforcing element and housing shells is required in order to provide a circumferentially closed tie.

A synthetic tie which consists of a composite material can be found in DE 699 38 308 T2. The composite material has a core layer and a surface layer which contains a heat-curable resin which is reinforced by long fibers.

DE 600 32 241 T2A discloses a similar construction, namely inter alia a composite with a textured fiber material which comprises a cellulose or lignin-containing cellulose material with internal fibers and a resin, wherein the internal fibers are exposed.

A thermoplastic material containing recycling polyolefin and glass fibers is known from DE 10-2011-117 760 A1. A shaped body in the form of a railroad tie can be produced from the material. As a result of the use of glass fibers, the disadvantage is, on the one hand, that severe wear of the ties can occur during compounding. The shaped body is not suitable as recycled material due to the glass fibers contained therein.

BRMU8502972U describes a railroad tie with a layered structure.

DE 20-2010-009 863 U discloses a railroad tie made of concrete in which textiles are incorporated for reinforcement.

EP 2-925-929 B1 discloses a layer-like railroad tie which consists of bonded stone material and natural fiber layers.

Shaped bodies can be produced with mixers. Thermokinetic mixers which are used for melt blending are known from U.S. Pat. No. 5,895,790 A and EP 3-608-014 A1. In this case, polymer mixtures and thermocured waste material are converted back into usable products by first forming a thermocured material of a predictable quality from non-uniform polymers, and subsequent melt blending of the thermocured material with a thermoplastic material to give usable products.

The problem with the known shaped bodies is that the production is very complicated and cost-intensive. In addition, the shaped bodies are not recyclable.

The object of the invention is to provide a method for producing a shaped body from plastic waste which has sufficient flexural rigidity or strength.

The object is achieved by the features of claim 1. Preferred embodiments are described in the dependent claims.

The object is achieved according to the invention in that a method for producing a shaped body is provided, comprising the following steps:
a. Introducing plastic waste and thermoplastic plastic material comprising natural fiber components or thermoplastic plastic and natural fibers into a mixing device,
b. Mixing the introduced materials in such a way that the materials from a. are comminuted and at least partially melt so that a substantially moldable base material is available after mixing,
c. Transferring the at least partially melted base material into a mold for shaping and pressing the base material into an outer geometry of the shaped body.

The shaped body produced using the method according to the invention consists of a plastic in which natural fiber particles are present in a quasi-chaotic manner. This means that the natural fiber particles are present in the plastic in a random manner. The natural fiber particles are surrounded by the plastic in a substantially form-fitting manner. The advantage of the shaped body according to the invention is, for example, that natural fibers are used, the handling of which is much simpler and above all less hazardous than, for example, reinforcements made of glass fiber or steel. In addition, the designing freedom is greater and more varied, since the natural fibers are present in the shaped body in a substantially integrated manner as fragments or particles, and reproducible production therefore does not have to be ensured. It has also been shown that the shaped bodies produced in this manner can be easily processed afterwards. They can, for example, but not exclusively, be sawn, milled or also welded. This is advantageous, in particular, when the shaped body has to be processed or adapted to the intended use after production, but before its use (and optionally on site).

In a preferred embodiment, the mixture is mixed in the mixing device at 1200-2700, in particular 1500-2500 revolutions per minute. A mixing time of 5-60 seconds, in particular 10-20 seconds, has proven to be particularly advantageous. This means that very short mixing times are possible with the preferred method so that a short cycle time can be achieved. As a result of the preferred revolutions, high shear forces can be exerted on the mixture on the one hand, and, consequently, sufficient energy can be introduced for the mixing of the materials. On the other hand, excessive heating and, consequently, also undesired chemical processes, can be prevented, in particular due to a low mixing time.

Furthermore, the natural fiber is a natural product, i.e., a renewable raw material, which is formed with plastic waste into a new product. The recycling of a shaped body produced using the method according to the invention is consequently unproblematic, since the shaped body can simply be shredded again and reused in the method.

The natural fiber particles are enclosed and fixed in their location or position by being mixed with the base materials and the corresponding surface melting of the plastics. As a result, a shaped body with high flexural rigidity or strength can be provided.

Within the meaning of the invention, a mixing device can be an extruder or a thermokinetic mixer (compounder).

A shaped body within the meaning of the invention is a body which can be produced using the method according to the invention and whose geometric shape is achieved, in particular, by pressing the base material into a correspondingly geometrically shaped outer geometry.

In one embodiment, it is provided that the components according to step a. are shredded before being introduced into the mixing device. This can be advantageous in order, for example, to make pre-cleaning of the materials easier, or just to simplify the handling of the materials.

It has also been found to be advantageous to eliminate metals and pulp from the components according to step a. before being introduced into the mixing device, in particular after shredding or prior to shredding. Metals and pulp, such as cellulose, can damage the integrity of the shaped body and prove problematic during processing. In a preferred embodiment, metals and pulp are eliminated from the materials to be introduced prior to introduction by physical or chemical methods. The shaped bodies produced thereby have a higher purity or quality.

It can be provided that the components according to step a. are dedusted before being introduced into the mixing device, or before or after eliminating metals and pulp. By dedusting, for example by blowing in compressed air or by other physical methods, the purity of the shaped bodies is improved. It has also been found that the temperature during mixing is then more constant and therefore easier to monitor or control.

It is preferred that a mixture of polymers, in particular polyolefins, in particular one or more materials from the group of polyethylene, LDPE and/or HDPE polyethylene, polypropylene, polyvinyl chloride, polyethylene terephthalate, polycarbonate, polyamide, acrylonitrile-butadine-styrene, polymethyl diacrylate and polystyrene, is used as the thermoplastic material. Polyolefins have proven to be particularly advantageous, with other plastics also being usable. Undesired or less desired plastic compounds can be used, for example, as filling material, which can be advantageous, in particular, for recycling.

An average size of the plastics, in particular of the shredded plastics, between 1.0 cm and 3.0 cm has been found to be advantageous for the method. This results in rapid and effective mixing and a good shear rate.

A mixture of pre-sorted recycled and in particular shredded plastic materials which advantageously already comprise natural fibers can preferably be used as thermoplastic material. Particularly useful are waste products which also include natural fibers in addition to thermoplastic plastics. This product is advantageously mixed with further plastic waste.

It is preferred that the particles in the mixing device are heated to a maximum temperature T of 130° C.≤T≥250° C., in particular T≈150° C. The temperature should be kept substantially constant during the entire mixing process. Independently of this, a temperature acts on the components in the device, by means of which at least surface melting and not necessarily complete melting takes place, even though individual components or particles can also be melted completely. Only partially melting affords the advantage that long-chain polymer molecules are conserved, with the result that the material itself has a higher strength in the solidified state compared to materials produced by extrusion.

In order to change chemical or physical properties of the shaped body produced using the method and, for example, to adapt said shaped body to a defined intended use already during production, chemical additives can be added in step b. These additives can be added in amounts of about 0.5 to about 20-30% by weight. Examples of useful additives are, for example, calcium carbonate or silicon dioxide.

In a preferred embodiment, the thermoplastic material already comprises natural fibers in the form of a waste material produced in the automotive industry. In the case of this waste material, the natural fibers are pressed in the thermoplastic material. However, since the natural fibers in the thermoplastic plastic are present in the form of mats in this embodiment, it is advantageous if the thermoplastic material with the natural fibers is shredded before use. However, it can also be advantageous if a combination of thermoplastic material and natural fibers is not used, but they are instead introduced separately into the mixing device.

For example, thermoplastic waste products and, for example, natural fiber pellets can be used. Irrespective of the form of use of the natural fibers, an amount of the natural fibers in the end product of about 10% by weight to 50% by weight is preferred. It has been found that such an amount can be processed easily and leads to a stable shape. In particular, it is advantageous if the thermoplastic polymer comprises natural fibers at an amount of 10% by weight to 50% by weight.

For example, flax and/or hemp can be used as natural fibers. The natural fibers can be present individually or as a combination in the shaped body.

It has been found to be preferable if the particle size of the natural fiber particles is in the range from 1 mm to 20 mm, preferably in the range from 5 mm to 15 mm and particularly preferably in the range from 3 mm to 10 mm. Natural fiber particles having a size of 3 mm to 10 mm are optimally enclosed by the plastic and achieve virtually the same physical properties as known reinforcements. Natural fiber particles having a size of 1 mm to 20 mm become entangled with one another, so that essentially a matrix of natural fibers is built up in the shaped body. The same applies substantially to the natural fiber particles having a size of 5 mm to 15 mm, among which, however, the interactions are not as strong and not as pronounced, so that individual natural fibers are also present.

Furthermore, the invention relates to a shaped body, in particular a railroad tie produced using the method, comprising a base body made of thermoplastic material and plastic waste, in which natural fiber particles are present as reinforcement, in particular in an unstructured manner, in particular in a random manner. The base body of the railroad tie consists of a plastic in which natural fiber particles are present in a quasi-chaotic manner. This means that the natural fiber particles are present, in particular, in a random manner in the plastic. The natural fiber particles are surrounded by the plastic in a substantially form-fitting manner. The advantage of the tie according to the invention, for example, that natural fibers are used, the handling of which is substantially simpler and above all non-hazardous than, for example, reinforcements made of glass fiber. In addition, the designing freedom is greater and more varied, since the natural fibers are present in the tie in an integrated manner substantially as fragments or particles, and reproducible production therefore does not have to be ensured. Furthermore, this is a natural product, i.e. a renewable raw material.

Recycling a tie according to the invention is therefore unproblematic, since the plastic can easily be melted again.

Surprisingly, it has been found that by using the natural fibers as reinforcement, a thermal linear expansion coefficient is achieved which substantially corresponds to that of railroad ties which have, e.g., metal rods as reinforcement or are fiberglass-reinforced. This means that the thermal elongation of the plastic is substantially prevented by the random embedding of the natural fibers, as a result of which the desired flexural rigidity and strength of the railroad tie are also ensured. In addition to a portion of plastic waste, the base body of the preferred embodiment also comprises a portion of thermoplastic plastic. It has been found that a mixture of both plastics leads to a railroad tie which has the necessary physical properties and is also easy to form. The subsequent processability of the tie is advantageous because the tie can be cut, for example, before being installed or processed in another way. The thermoplastic plastic is in particular present in an amount of 10% by weight to 90% by weight. Such a proportion of thermoplastic plastic has proven to be advantageous, since this makes it possible to generate a base material which is easy to process or form.

The invention will explained in greater detail below with reference to embodiments of the invention which are illustrated in the drawings.

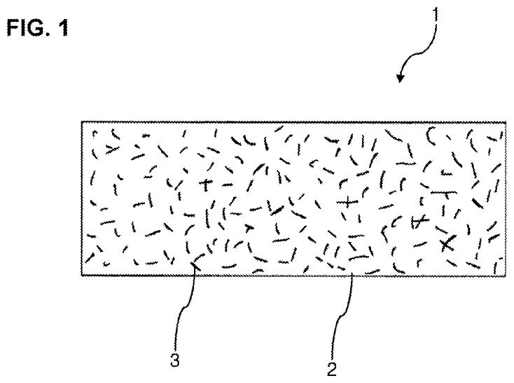

FIG. 1 shows a preferred embodiment of a cuboid-shaped shaped body produced using the method. This can be, for example, a railroad tie or any other rectangular shaped body 1. The shown shaped body 1 is merely an example and does not limit the disclosure thereto, since other shaped bodies 1 with other geometric shapes can also be produced with the method according to the invention. Examples thereof are excavator mats, pallets, bridge pillars, building materials, etc.

The shaped body 1 can have a cuboid shape and comprise a base body 2 made of a plastic in which natural fibers 3 are present in an unstructured manner in a chaotic arrangement.

The shaped body 1 consists of a matrix material and comprises plastic waste as the plastic material in an amount of approximately 90% by weight to 10% by weight, and a thermoplastic material. The thermoplastic material is, in particular, selected from the group comprising polyethylene, polypropylene, polyvinyl chloride, polyethylene terephthalate, polycarbonate, polyamide, aryl nitrile-butadine-styrene, polymethyl/acrylate and polystyrene. Either the thermoplastic material already comprises natural fibers, which can be the case when a waste product of the automotive industry is used. Surprisingly, mats made of a thermoplastic material, in particular polypropylene and natural fibers, which are used in the automotive industry inter alia as a component of the bodywork, can be used for the production of the shaped bodies 1. In these mats, natural fiber layers are present embedded by thermoplastic, in particular at a ratio of 50/50, i.e., in particular 50% by weight thermoplastic and 50% by weight natural fibers. This waste product in the form of natural fibers and thermoplastic can be mixed in an amount of 10% by weight to 90% by weight with a corresponding amount of plastic waste. Tests have shown that, in principle, 100% by weight of this product can also be used for the preferred method for producing a shaped body 1.

However, it may also be advantageous to not use a compound of thermoplastic and natural fibers, but to introduce them separately into the mixing device. In this case, the natural fibers can be used, for example, in the form of pellets.

For the production of the shaped body 1, for example a railroad tie, corresponding used materials are first pre-sorted, shredded and dried, wherein the individual shredded fragments can have a mean size between 1.0 mm and 15.0 mm, in particular between 1.0 mm and 3.0 mm. This means that the mats of thermoplastic and natural fibers described above are also comminuted.

Before the materials are introduced into the mixing device and before or after shredding, metals and pulp are eliminated. The elimination of pulp has proven to be advantageous for the properties of the shaped body 1. This is because, in the processing of pulp in a mixing device, problems often arise since, for example, the pulp clogs the mixer of the mixing device and therefore disadvantageously influences the mixing process. As a result, a corresponding shaped body 1 can comprise an irregularity in the base material, which can adversely affect the physical property of the shaped body. Finally, and preferably directly before the materials are introduced into the mixing device, dust is removed so that dust, in particular light pulp, is removed from the material. This has proven to be particularly advantageous, since by doing so, the temperature during the mixing process can be better controlled, which in turn leads to a shaped body of higher quality.

In the desired mixing ratio, optionally with added talcum, and/or a crosslinking agent, and/or an antioxidant, the materials are then fed to a thermokinetic mixing device, which is described, for example, in EP 3-608-014 A1 or WO 2021/155875 A1, the disclosure of which is expressly referenced. In addition, reference is also expressly made to the disclosure of U.S. Pat. No. 5,895,790 A which also belongs to the disclosure of the present application. Alternatively, the materials can also be added to an extruder.

In the thermokinetic mixing device, the particles are compounded in such a way that not all particles melt completely, but only melt at their surfaces, so that adhesion, that is to say agglomeration, occurs. Because not all particles are completely melted, a destruction of long-chain polymer molecules is prevented or reduced so that the material itself already has a greater strength compared to a shaped body 1 that is otherwise produced from thermoplastic material. In addition, the natural fibers 3 are comminuted to a preferred particle size of 1 mm to 20 mm. The particle size can be influenced, for example, by the duration of mixing. Alternatively, the natural fibers 3 can also be comminuted to the preferred size before being introduced into the mixing device.

The desired flexural rigidity or strength of the shaped body 1, for example of a railroad tie itself, is then provided by the natural fibers 3. In particular flax, hemp or a combination thereof is suitable as materials for the reinforcement made of natural fiber 3. Corresponding shaped bodies 1 can therefore be easily recycled.

To produce the shaped bodies 1, a tool can be used, the internal geometry of which corresponds to the outer geometry of the shaped body 1 to be produced. In the example shown in FIG. 1, the shaped body 1 has a cuboid shape. The tool can have, for example, a box shape with, in particular, a hollow cuboid geometry into which the at least partially melted plastic is added from the mixer.

One advantage of the method is that, due to the external structure of the natural fibers 3, the solidified plastic material encloses the natural fibers 3 in a form-fitting manner, so that, irrespective of the different coefficients of expansion, there is no longitudinal displacement to one another, which in turn ensures the desired flexural rigidity and strength of the shaped body 1.

Another advantage of the use of the shaped body 1 made of plastic is also that subsequent processing of the shaped body 1 is possible without damage to the integrity of the shaped body 1. It can be advantageous, for example, if railroad ties are subsequently cut to length on site so that they fit better.

1. A method for producing a shaped body (1) comprising the following steps:
a. introducing plastic waste and thermoplastic plastic material comprising natural fiber components or thermoplastic plastic and natural fibers into a mixing device,
b. mixing the introduced materials in such a way that the materials from step a. are comminuted and at least partially melt so that a substantially moldable base material is available after mixing, and
c. transferring the at least partially melted base material into a mold for shaping and pressing the base material into an outer geometry of the shaped body (1).

2. The method according to claim 2, wherein the components according to step a. are shredded before being introduced into the mixing device.

3. The method according to claim 1, wherein metals and pulp are eliminated from the components according to step a. before being introduced into the mixing device or prior to shredding.

4. The method according to claim 1, wherein the components according to step a. are dedusted before being introduced into the mixing device, or before or after eliminating metals and cellular materials.

5. The method according to claim 1, wherein the thermoplastic material used is a mixture of polymers, in particular polyolefins, in particular one or more materials from the group of polyethylene, polypropylene, polyvinyl chloride, polyethylene terephthalate, polycarbonate, polyamide, acrylonitrile-butadine-styrene, polymethyl diacrylate, and polystyrene.

6. The method according to claim 1, wherein an average size of the particles is between 1.0 cm and 3.0 cm.

7. The method according to claim 1, wherein the mixture is cooled in accordance with step b., so that the mixture is heated to a maximum temperature T of 130° C.≤T≥250° C., in particular T≈150° C.

8. The method according to claim 1, wherein chemical additives are added in step b.

9. The method according to claim 1, wherein the thermoplastic material is present in an amount of 10% by weight to 90% by weight.

10. The method according to claim 1, wherein the thermoplastic polymer comprises natural fibers at an amount of 10% by weight to 50% by weight.

11. The method according to claim 1, wherein the natural fibers are flax and/or hemp.

12. The method according to claim 1, wherein the particle size of the natural fiber particles (3) is in a range from 1 mm to 20 mm.

13. The method according to claim 1, wherein the plastic waste comprises mixed plastics, polymer mixtures, and/or thermocured waste materials.

14. A railroad tie (1) produced using the method according to claim 1, having a base body made of thermoplastic material and plastic waste, in which as reinforcement natural fiber particles (3) are present in a random manner.
